(19) United States
(12) Patent Application Publication
(10) Pub. No.: US 2022/0152504 A1
(43) Pub. Date: May 19, 2022

(54) RECORDING MEDIUM, INFORMATION PROCESSING METHOD, AND INFORMATION PROCESSING APPARATUS

(71) Applicant: KOEI TECMO GAMES CO., LTD., Kanagawa (JP)

(72) Inventors: Hidehiko NAKAJIMA, Kanagawa (JP); Kazuhiro NISHIMURA, Kanagawa (JP)

(21) Appl. No.: 17/454,644

(22) Filed: Nov. 12, 2021

(30) Foreign Application Priority Data
Nov. 19, 2020 (JP) 2020-192228

(51) Int. Cl. A63F 13/56; G06T 19/20

(52) U.S. Cl. CPC A63F 13/56; G06T 2219/2004; G06T 19/20

(57) ABSTRACT

A non-transitory computer-readable recording medium stores a program that causes a computer to execute a process performed in an information processing apparatus. The process includes correcting a second motion of a second object that is riding a first object that moves based on a first motion, such that a predetermined position of the second object is arranged at a predetermined position of the first object; correcting the second motion such that a posture of the second object is based on a movement of the first object or an environment; and displaying an image of the second object that is riding the first object based on the corrected second motion.

### CROSS-REFERENCE TO RELATED APPLICATION

The present application is based on and claims priority under 35 U.S.C. § 119 to Japanese Patent Application No. 2020-192228, filed on Nov. 19, 2020, the contents of which are incorporated herein by reference in their entirety.

### BACKGROUND OF THE INVENTION

### 1. Field of the Invention

The present invention relates to a recording medium, an information processing method, and an information processing apparatus.

### 2. Description of the Related Art

Conventionally, there is known an image generating apparatus that arranges a plurality of objects in an object space that is a virtual three-dimensional space, and generates a view image from a given viewpoint. In this type of image generating apparatus, the motion of a display object is often illustrated based on motion data. On the basis of the motion data, an object of a game character configured by primitive planes such as a polygon or curved surfaces, is operated in an object space. This enables the expression of the motions or the like of a game character that sequentially change.

In order to increase the degree of variety of the motions of the game character, it is desirable to prepare as many pieces of motion data as possible with respect to one game character (see, for example, Patent Document 1).
Patent Document 1: Japanese Unexamined Patent Application Publication No. H11-144086

In the technique described in Patent Document 1, the motions of the object are corrected in real time and used, based on the position information of the correction point and the reference motion data in a certain frame, so that a reference point included in a given part of the object to which a plurality of parts are connected, is arranged at a given correction point. Accordingly, the degree of variety of the motions of the displayed object can be increased without preparing so many pieces of motion data in advance.

However, when the motion of a person riding a vehicle is corrected by the technique disclosed in Patent Document 1, there has been a problem that, for example, the motion of the person riding the vehicle may become unnatural depending on the movement of the vehicle and the environment.

A problem to be addressed by an embodiment of the present invention is to realize natural motions of an object that is riding another object, while reducing the burden of creating motions.

### SUMMARY OF THE INVENTION

According to one aspect of the present invention, there is provided a non-transitory computer-readable recording medium storing a program that causes a computer to execute a process performed in an information processing apparatus, the process including correcting a second motion of a second object that is riding a first object that moves based on a first motion, such that a predetermined position of the second object is arranged at a predetermined position of the first object; correcting the second motion such that a posture of the second object is based on a movement of the first object or an environment; and displaying an image of the second object that is riding the first object based on the corrected second motion.

### BRIEF DESCRIPTION OF THE DRAWINGS

FIG. 1 is a diagram illustrating an example of a hardware configuration of an information processing apparatus according to an embodiment of the present embodiment;

FIG. 2 is a diagram illustrating an example of a functional configuration of an information processing apparatus according to an embodiment of the present embodiment;

FIG. 3 is a diagram illustrating an overview of motion correction and posture correction according to an embodiment of the present embodiment;

FIG. 4 is a diagram illustrating a process of motion correction and posture correction according to an embodiment of the present embodiment;

FIG. 5 is a flowchart illustrating an example of a process of displaying a rider object and a vehicle object according to an embodiment of the present embodiment;

FIG. 6 is a flowchart illustrating an example of the processing procedure in step S16 of FIG. 5 according to an embodiment of the present embodiment; and

FIG. 7 is a diagram illustrating a motion example of a rider object for which motion correction and posture correction are performed and a vehicle object according to an embodiment of the present embodiment.

### DESCRIPTION OF THE EMBODIMENTS

Hereinafter, embodiments for carrying out the present invention will be described with reference to the drawings.

### [Hardware Configuration]

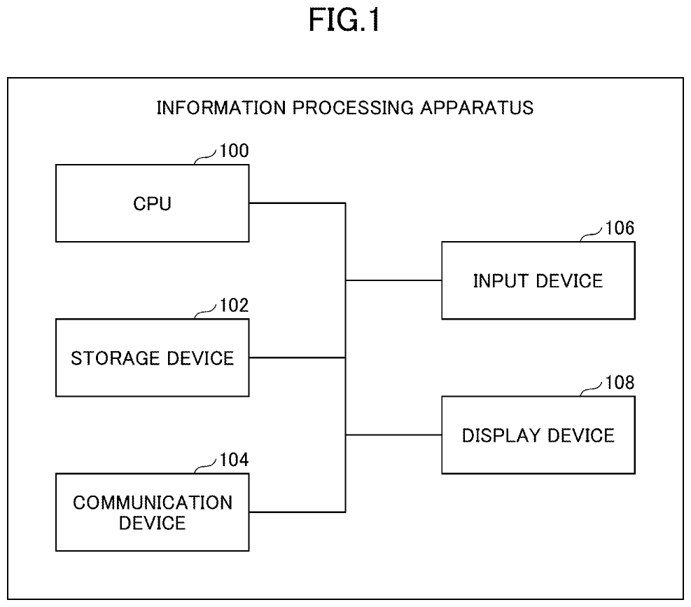

First, an information processing apparatus according to an embodiment will be described with reference to FIG. 1. FIG. 1 is a diagram illustrating an example of a hardware configuration of an information processing apparatus. The information processing apparatus of FIG. 1 is a personal computer, a cellular phone such as a smartphone, a portable game machine, a tablet terminal, a home game device, a commercial game device, or the like.

The information processing apparatus of FIG. 1 includes, for example, a CPU (Central Processing Unit) 100, a storage device 102, a communication device 104, an input device 106, and a display device 108. The CPU 100 controls the information processing apparatus according to a program. The storage device 102 may be, for example, a memory such as a ROM (Read Only Memory) or a RAM (Random Access Memory) or a storage such as a HDD (hard disk drive) or a SSD (Solid State Drive). The storage device 102 stores programs executed by the CPU 100 and data.

The communication device 104 is a communication device such as a network circuit that controls communication. The input device 106 is an input device such as a touch pad, a controller, a mouse, a keyboard, a camera, a microphone, or the like. The display device 108 is an output device such as a display, a speaker, or the like. A touch panel is implemented by combining a touch pad and a display.

The hardware configuration illustrated in FIG. 1 is an example and may be implemented, for example, in an information processing system including a server and a client. The server transmits and receives data to and from the client, thereby providing the client with a function to accept information such as characters and commands input by the user to the client, and to perform a process according to the information such as characters and commands, or the like. The server may be implemented by a cloud computer. The number of servers is not limited to one, and processes may be distributed over two or more servers. The server may also be used to perform a downloading process to provide programs required to use the service, to the client.

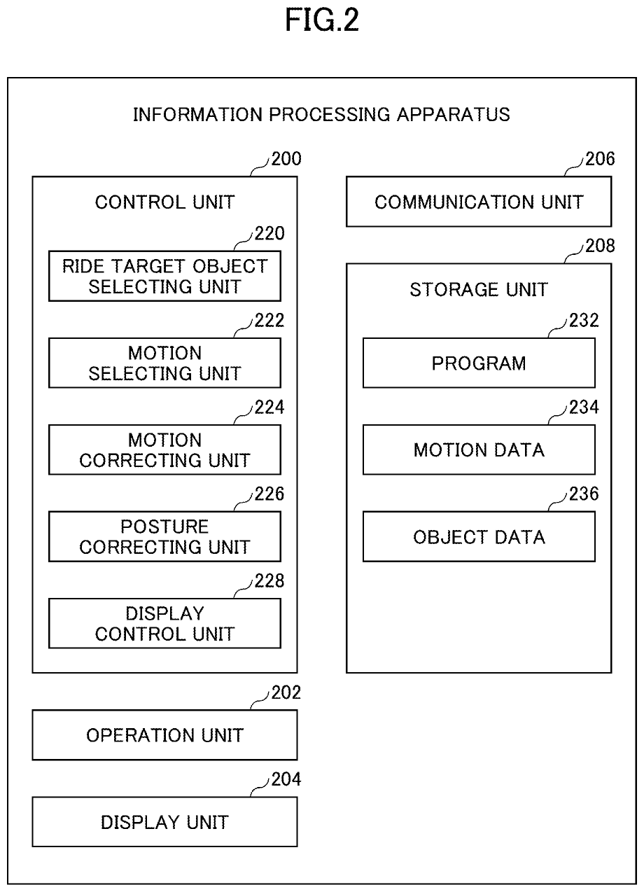

FIG. 2 is a diagram illustrating an example of a functional configuration of an information processing apparatus according to the present embodiment. The information processing apparatus of FIG. 2 includes a control unit 200, an operation unit 202, a display unit 204, a communication unit 206, and a storage unit 208. The storage unit 208 stores a program 232, motion data 234, and object data 236. The storage unit 208 may be implemented by the storage device 102 or may be implemented by a storage device connected via a network or the like.

Motion data is an example of information that defines the motion of an object of a vehicle, such as a horse or a motorcycle, or an object of a person riding the vehicle. Object data is an example of information of an object that is a vehicle, such as a horse and a motorcycle, for which the motion is defined by motion data, and an object that is a person riding the vehicle. Hereinafter, an object that is a vehicle, such as a horse and a motorcycle, is referred to as a “vehicle object”. An object riding the vehicle object is referred to as a “rider object”.

The control unit 200 performs the overall control of the information processing apparatus. The overall control of the information processing apparatus includes, for example, control of causing an object to move in an object space unit based on motion data. The control unit 200 is implemented by performing a process described in a program, by the CPU 100. The control unit 200 includes a ride target object selecting unit 220, a motion selecting unit 222, a motion correcting unit 224, a posture correcting unit 226, and a display control unit 228.

The ride target object selecting unit 220 selects an object that is the ride target from among the objects displayed in the object space. The ride target objects selected by the ride target object selecting unit 220 are a vehicle object and a rider object.

The motion selecting unit 222 selects the motion to be applied to the object that is the ride target, from the motion data of the object that is the ride target. For example, the motion selecting unit 222 selects the motion data to be applied to the vehicle object selected by the ride target object selecting unit 220 and the motion data to be applied to the rider object selected by the ride target object selecting unit 220.

When the motion correction of the rider object is performed as described below, the motion selecting unit 222 selects motion data of a posture (a neutral posture) that serves as a reference for correction by the motion correcting unit 224, which will be described later, as the motion data to be applied to the rider object.

The motion correcting unit 224 corrects the motion data to be applied to the rider object selected by the motion selecting unit 222 as described below and applies the corrected motion data to the rider object so that the motion of the vehicle object can be matched with the motion of the rider object riding the vehicle object.

For example, when the vehicle object is a bicycle and the rider object is a person, the motion correcting unit 224 corrects the motion of the rider object so that the hand follows the handle position, the foot follows the pedal position, and the backside follows the saddle position.

The posture correcting unit 226 corrects the motion of the rider object so that the posture of the rider object is based on the movement (action or shifting) of the vehicle object or the environment (a slope or a step), so that the motion of the rider object riding a vehicle object becomes natural.

The display control unit 228 causes the display unit 204 to display an image of the rider object riding a vehicle object, based on the motion corrected by the motion correcting unit 224 and the posture correcting unit 226.

The operation unit 202 accepts various operations of a user with respect to the input device 106. The display unit 204 displays various screens on the display device 108 according to the control of the display control unit 228. The operation unit 202 is implemented by controlling the input device 106 by the CPU 100 according to a program. The display unit 204 is implemented by controlling the display device 108 by the CPU 100 according to a program. The user's various operations with respect to the input device 106 refer to operations performed by the user on the operation unit 202 in order to cause the CPU 100 to execute operations. The display unit 204 displays various screens according to the control of the control unit 200. The communication unit 206 communicates via a network or the like. The communication unit 206 is implemented when the CPU 121 executes a program and controls the communication device 104 according to the program.

### [Process]

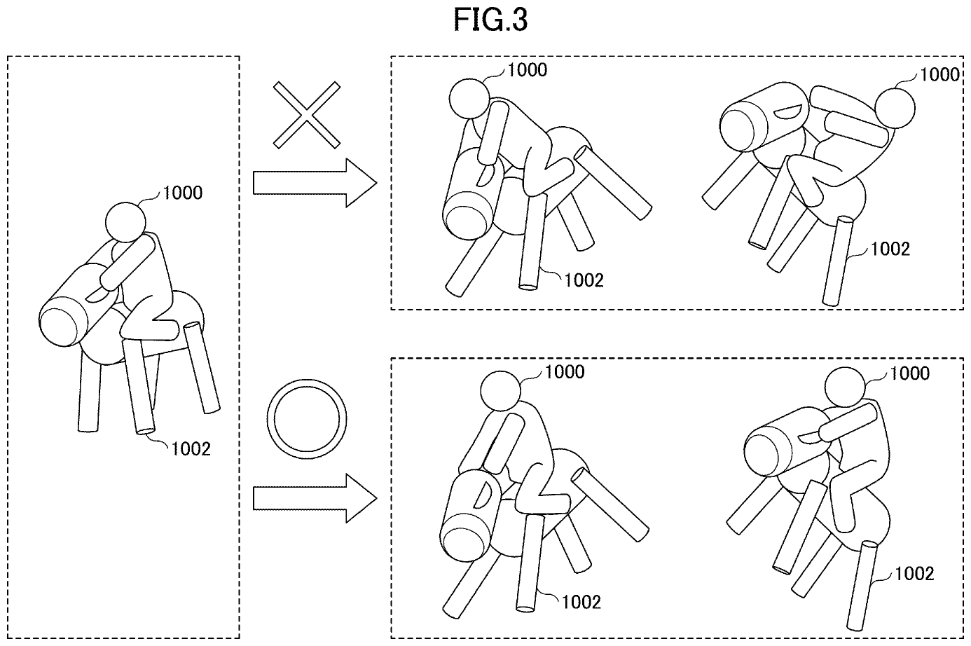

In the example described below, a vehicle object 1002 is a horse and a rider object 1000 is a person. FIG. 3 is a diagram illustrating the overview of motion correction and posture correction according to the present embodiment. The rider object 1000 riding the vehicle object 1002 illustrated on the left of FIG. 3 is in a state where motion data of a neutral posture is applied.

The rider object 1000 illustrated on the left in FIG. 3 has the hand thereof positioned at the rein of the horse that is the vehicle object 1002, has the foot thereof positioned at the kicking strap of the horse, and has the backside thereof positioned at the saddle of the horse. The right side of FIG. 3 illustrates the state where the posture of the vehicle object 1002 has changed from the posture illustrated on the left of FIG. 3.

The upper right example of FIG. 3 is a motion example of the rider object 1000 in which motion data of a neutral posture is applied without modification when the posture of the vehicle object 1002 leans forward or backward. In the upper right example of FIG. 3, the motion of the rider object 1000 appears unnatural, because the rider object 1000 tilts together with the vehicle object 1002 due to the change in posture of the vehicle object 1002, and thus the rider object 1000 appears to be swung around by the vehicle object 1002.

The lower right example of FIG. 3 is a motion example of the rider object 1000 in which the posture of the rider object 1000 is made to be close to a perpendicular state (original posture angle) rather than applying motion data of a neutral posture without modification, when the posture of the vehicle object 1002 is leaning forward or backward. In real life, a person will attempt to keep his or her posture perpendicular to the ground, as in motion data of a neutral posture, rather than tilting together with the horse when the horse ridden by the person rises up, or runs up a slope, for example. Therefore, in the example at the lower right of FIG. 3, the motion of the rider object 1000 with respect to changes in the posture of the vehicle object 1002 appears natural, by correcting the posture of the rider object 1000 to be maintained perpendicular to the ground so that the rider object 1000 does not tilt together with the vehicle object 1002.

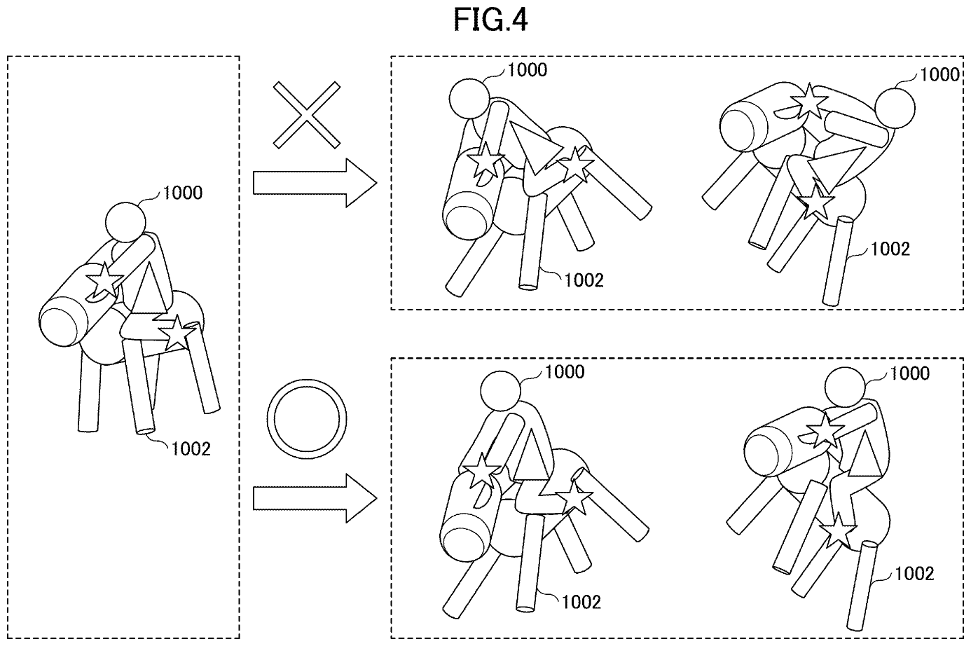

Accordingly, in the present embodiment, motion correction and posture correction of the rider object 1000 are performed as illustrated in FIG. 4 so as to appear like the example on the bottom right of FIG. 3, by correcting the motion data of the neutral posture of the rider object 1000 riding the vehicle object 1002 illustrated on the left of FIG. 3. FIG. 4 is a diagram illustrating a process of motion correction and posture correction according to the present embodiment.

In FIG. 4, predetermined positions (hereinafter referred to as hand and foot attach nodes) of the vehicle object 1002 at which the hand and foot of the rider object are to be arranged, are indicated by star marks. In FIG. 4, a predetermined position (hereinafter, referred to as a rider attach node) on the vehicle object 1002 where the backside of the rider object is to be arranged and the posture angle of the rider object 1000, are indicated by a triangular mark.

With respect to the rider object 1000 illustrated on the left in FIG. 4, the hand and foot (of the rider object) are arranged at the positions of the hand and foot attach nodes of the vehicle object 1002, and the backside (of the rider object) is arranged at the position of the rider attach node of the vehicle object 1002. In FIG. 4, the state where the posture of the vehicle object 1002 has changed from the posture illustrated on the left, is illustrated on the right.

The upper right example of FIG. 4 illustrates a motion example of the rider object 1000 in which motion data of a neutral posture is applied without modification when the posture of the vehicle object 1002 leans forward or backward. For example, in the upper right example of FIG. 4, the hand of the rider object 1000 is parted away from the position of the hand and foot attach node of the vehicle object 1002. Further, in the example on the upper right of FIG. 4, the posture angle of the rider object 1000 is tilted together with the vehicle object 1002, so that the rider object 1000 appears to be swung around due to the change in the posture of the vehicle object 1002, thereby appearing unnatural.

In the lower right example of FIG. 4, the motion is corrected so that the hand and foot of the rider object 1000 are arranged to follow the positions of the hand and foot attach nodes of the vehicle object 1002, rather than applying the motion data of a neutral posture without modification, when the posture of the vehicle object 1002 leans forward or backward. In the example illustrated in the lower right of FIG. 4, the motion of the rider object 1000 is corrected so that the posture angle of the rider object 1000 is almost an angle of a neutral posture. In the lower right example of FIG. 4, the motion of the rider object 1000 with respect to the change in the posture of the vehicle object 1002 appears natural, because the positions of the hand and foot of the rider object 1000 are not separated from the positions of the hand and foot attach nodes of the vehicle object 1002 and the posture angle is corrected to remain perpendicular to the ground.

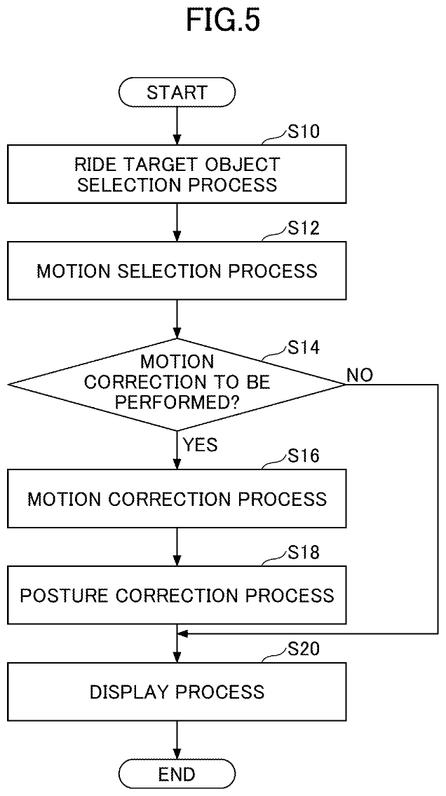

FIG. 5 is a flowchart illustrating an example of a process of displaying a rider object and a vehicle object according to the present embodiment. In step S10, the ride target object selecting unit 220 selects the rider object 1000 and the vehicle object 1002 that are ride targets from among the objects to be displayed in the object space. The rider object 1000 and the vehicle object 1002 that are ride targets can be identified by, for example, setting values.

In step S12, the motion selecting unit 222 selects the motion to be applied to the rider object 1000 and the motion to be applied to the vehicle object 1002 that are ride targets, respectively. Here, an example of selecting motion data of a neutral posture of the rider object 1000 that is a ride target will be described. When a special motion is to be implemented by the rider object 1000, motion data exclusively used for the special motion is selected.

In step S14, if “motion correction to be performed” is set with respect to the selected motion of the rider object 1000, the motion correcting unit 224 performs the processes of steps S16 and S18. In step S16, the motion correcting unit 224 corrects the motion data selected by the motion selecting unit 222 to be applied to the rider object 1000 so that the hand and foot of the rider object 1000 are respectively arranged at the positions of the hand and foot attach nodes of the vehicle object 1002.

In step S16 and step S18, for example, the motion correcting unit 224 and the posture correcting unit 226 adjust the position and a posture angle of the rider attach node represented by a triangular mark in FIG. 4 in accordance with the movement of the vehicle object 1002, and arranges the backside of the rider object 1000 on the vehicle object 1002 according to the position and a posture angle of the rider attach node, thereby correcting the motion data to be applied to the rider object 1000 so that the rider object 1000 is close to a neutral posture.

The posture correcting unit 226 corrects the motion of the rider object so that the posture of the rider object 1000 is based on the movement (action or shifting) of the vehicle object 1002 or the environment (a slope or a step).

For example, when the vehicle object 1002 on which the rider object 1000 is riding accelerates, the posture correcting unit 226 makes a correction such that the posture angle of the rider object 1000 (for example, the angle from the hip to the spine, the angle of the head, or the like) is tilted backward in accordance with the acceleration ratio. As an example of the calculation method of the acceleration ratio, the acceleration ratio can be calculated by using the equation of (“movement amount in the previous frame”−“movement amount in the current frame”)/“movement amount in the previous frame”. As an example of the posture angle correction method, when the coordinates at which the head of the rider object 1000 is positioned in the previous frame are set to 100% and the coordinates at which the head is positioned in the current frame are set to 0%, the coordinates of the interpolation target are calculated by the acceleration ratio (0% to 100%), and the angle correction is performed toward the calculated coordinates. Similarly, when the moving vehicle object 1002 on which the rider object 1000 is riding decelerates, the posture correcting unit 226 makes a correction so that the posture angle of the rider object 1000 is tilted forward in accordance with the deceleration ratio. Note that, in order to prevent the posture angle from being unnatural, the correction of the posture angle of the rider object 1000 by the posture correcting unit 226 may be performed upon defining an upper limit angle by which the posture can be tilted, for each of the front, rear, left, and right directions. Further, in order to prevent the posture angle from being unnatural, the correction of the posture angle of the rider object 1000 by the posture correcting unit 226 may be performed by gradually changing the angle such as in the order of the hip, the lower part of the spine, and the upper part of the spine. Further, in order to prevent the posture angle from being unnatural, the correction of the posture angle of the rider object 1000 by the posture correcting unit 226 may be performed by defining an upper limit angle by which the posture angle can be tilted for each frame.

For example, when the vehicle object 1002 on which the rider object 1000 is riding is on a slope, the posture correcting unit 226 acquires the ground angle and corrects the posture angle of the rider object 1000 so as to cancel out the acquired ground angle.

Further, the posture correcting unit 226 corrects the posture angle of the rider object 1000 so that, when the vehicle object 1002 on which the rider object 1000 is riding takes an action of rising up, the posture of the rider object 1000 is close to a perpendicular state (the original posture angle).

For example, when the vehicle object 1002 on which the rider object 1000 is riding passes over a step, the posture correcting unit 226 acquires the size of the step and corrects the posture angle of the rider object 1000 so that an oscillation corresponding to the acquired size of the step occurs.

In step S14, if “motion correction to be performed” is not set with respect to the selected motion of the rider object 1000, the motion correcting unit 224 skips the processes of step S16 and step S18. For example, the setting of “motion correction to be performed” is set in association with the rider object 1000 and the vehicle object 1002 that are the ride targets.

In step S20, the display control unit 228 displays an image of the rider object 1000 in the state of riding on the vehicle object 1002 on the display unit 204 based on the motion corrected by the motion correcting unit 224 and the posture correcting unit 226.

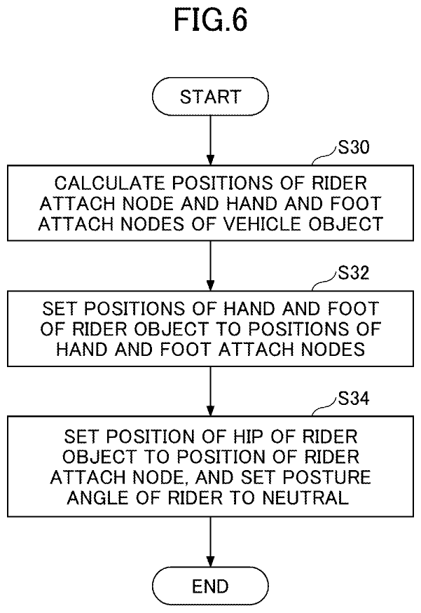

The motion correction process of step S16 is performed by, for example, the procedure illustrated in FIG. 6. FIG. 6 is a flowchart illustrating an example of a processing procedure of step S16. In step S30, the motion correcting unit 224 calculates the position of the rider attach node and the hand and foot attach nodes of the vehicle object 1002.

In step S32, the motion correcting unit 224 corrects the motion of the rider object 1000 so as to set the positions of the hand and foot of the rider object 1000 to the positions of the hand and foot attach nodes of the vehicle object 1002.

In step S34, the motion correcting unit 224 sets the position of the backside of the rider object 1000 to the position of the rider attach node and corrects the motion of the rider object 100 so that the posture angle of the rider object 1000 is close to a perpendicular state (the original posture angle).

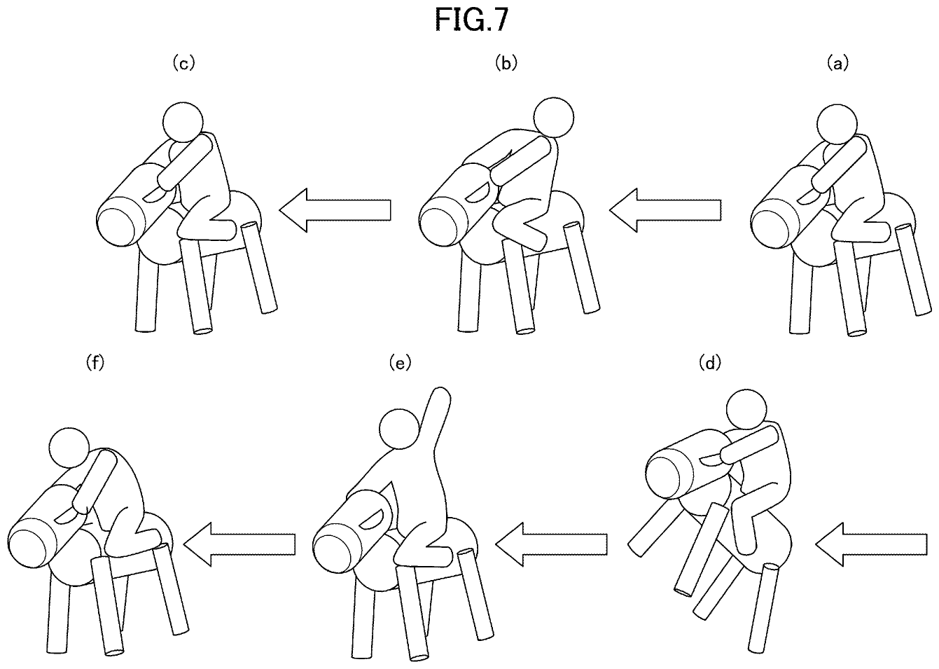

FIG. 7 is a diagram illustrating a motion example of a rider object and a vehicle object in which motion correction and posture correction are performed according to the present embodiment. FIG. 7 illustrates a series of motion examples of the rider object and the vehicle object.

FIG. 7(a) illustrates an example in which the vehicle object carrying the rider object is in a static state. FIG. 7(b) illustrates an accelerating state from the static state of FIG. 7(a). The vehicle object is accelerating, and, therefore, the rider object is corrected so that the posture angle is tilted backward. Further, the positions of the hand and foot of the rider object are set to the hand and foot attach nodes of the vehicle object.

FIG. 7(c) illustrates the state in which the acceleration is terminated after the state in FIG. 7(b). The acceleration is terminated, and, therefore, the rider object is corrected so that the posture angle returns to a state close to a perpendicular state (original posture angle).

FIG. 7(d) illustrates the vehicle object carrying the rider object, performing a rising up action. When the vehicle object performs an action of rising up, the posture angle of the rider object is corrected so that the posture of the rider object is close to a perpendicular state (original posture angle). Further, the positions of the hand and foot of the rider object are set to the hand and foot attach nodes of the vehicle object.

FIG. 7(e) illustrates a state in which the motion correction and the posture correction according to the present embodiment are switched from ON to OFF and exclusive-use motion data is applied to the rider object. In the motion correction and the posture correction according to the present embodiment, the timing of switching between ON and OFF can be set in a series of vehicle object motions. FIG. 7(e) illustrates a state in which the motion correction and the posture correction according to the present embodiment are turned off, so that the hand of the rider object is not set to the position of the hand and foot attach node of the vehicle object, and a motion in which the rider object raises the hand is implemented.

If the motion data illustrated in FIG. 7(e) is applied to the rider object in a state where the motion correction and the posture correction according to the present embodiment are turned on, the hand of the rider object will be set to the position of the hand and foot attach node of the vehicle object, and the intended motion cannot be implemented.

Further, when the motion correction and the posture correction according to the present embodiment are turned off, various motions, such as a motion in which the rider object stands on the vehicle object or a motion in which the rider object jumps on the vehicle object, can be implemented without unnaturally deforming the posture of the rider object. The switching of the motion correction and the posture correction according to the present embodiment between ON and OFF may be set such that only a portion (e.g., only the hand and foot) is turned off depending on the motion to be implemented.

FIG. 7(f) illustrates the state during deceleration. FIG. 7(f) illustrates a state in which the motion correction and the posture correction according to the present embodiment are switched on from off, and the neutral motion data is applied to the rider object again. In FIG. 7(f), the vehicle object is decelerating, and, therefore, the rider object is corrected so that the posture angle is tilted forward. Further, the positions of the hand and foot of the rider object are set to the hand and foot attach nodes of the vehicle object.

According to the present embodiment, when it is desired to cause the vehicle object and the rider object to perform different motions from each other, the motion of the vehicle object is used to correct and use the motion data of the neutral posture of the rider object, and, therefore, it is possible to reduce the motion data of the rider object required for moving the rider object in accordance with various motions of the vehicle object.

Accordingly, the natural motion of the rider object that is riding the vehicle object can be implemented while reducing the burden of creating motion data for the rider object.

According to one embodiment of the present invention, natural motions of an object that is riding another object can be realized, while reducing the burden of creating motions.

The recording medium, the information processing method, and the information processing apparatus are not limited to the specific embodiments described in the detailed description, and variations and modifications may be made without departing from the spirit and scope of the present invention. Further, the matters described in the above-described embodiments may take other configurations to the extent not inconsistent, and may be combined to the extent not inconsistent.

What is claimed is:

1. A non-transitory computer-readable recording medium storing a program that causes a computer to execute a process performed in an information processing apparatus, the process comprising:
correcting a second motion of a second object that is riding a first object that moves based on a first motion, such that a predetermined position of the second object is arranged at a predetermined position of the first object;
correcting the second motion such that a posture of the second object is based on a movement of the first object or an environment; and
displaying an image of the second object that is riding the first object based on the corrected second motion.

2. The non-transitory computer-readable recording medium according to claim 1, wherein the correcting includes moving the predetermined position of the first object in accordance with the movement of the first object on which the second object is riding.

3. The non-transitory computer-readable recording medium according to claim 1, wherein the correcting includes correcting the second motion of the second object such that the posture of the second object is in accordance with an acceleration ratio of the first object.

4. The non-transitory computer-readable recording medium according to claim 1, wherein the correcting includes correcting the second motion of the second object such that the posture of the second object is in accordance with a tilt of the first object.

5. The non-transitory computer-readable recording medium according to claim 1, wherein the correcting includes correcting the second motion of the second object such that each position of a hand, a foot, and a backside of the second object is arranged based on the predetermined position of the first object.

6. The non-transitory computer-readable recording medium according to claim 1, wherein the correcting includes setting a timing of switching between on and off of correcting the second motion during a series of the first motions.

7. An information processing method executed by an information processing apparatus, the information processing method comprising:
correcting a second motion of a second object that is riding a first object that moves based on a first motion, such that a predetermined position of the second object is arranged at a predetermined position of the first object;
correcting the second motion such that a posture of the second object is based on a movement of the first object or an environment; and
displaying an image of the second object that is riding the first object based on the corrected second motion.

8. An information processing apparatus comprising:
a motion correcting unit configured to correct a second motion of a second object that is riding a first object that moves based on a first motion, such that a predetermined position of the second object is arranged at a predetermined position of the first object;
a posture correcting unit configured to correct the second motion such that a posture of the second object is based on a movement of the first object or an environment; and
a display control unit configured to display an image of the second object that is riding the first object based on the corrected second motion.
